(19) United States
(12) Patent Application Publication
(10) Pub. No.: US 2018/0073703 A1
(43) Pub. Date: Mar. 15, 2018

(54) LIGHT MODULE FOR PROVIDING EFFECT LIGHT

(71) Applicant: OSRAM GmbH, Munich (DE)

(72) Inventor: Juergen Mueller, Berlin (DE)

(21) Appl. No.: 15/701,467

(22) Filed: Sep. 12, 2017

(30) Foreign Application Priority Data
Sep. 12, 2016 (DE) 10 2016 217 323.5

(51) Int. Cl. F21V 13/02; F21V 9/16; F21V 5/02; F21V 14/00

(52) U.S. Cl. CPC F21V 13/02; F21V 9/16; F21W 2131/406; F21V 14/006; F21V 5/02

(57) ABSTRACT

A light module for providing light includes a plurality of excitation radiation sources, wherein each source is designed to emit an excitation radiation beam at least at times, at least one phosphor designed to convert the excitation radiation impinging on it into conversion light, a phosphor device, which includes the phosphor, and which is designed to re-emit excitation radiation beams impinging on it and at least at times as conversion light beams or unconverted excitation radiation beams, a deflection device having at least one deflection optical unit, which deflection device is designed to direct at least some of the excitation radiation beams coming from the respective excitation radiation sources at times onto different regions of the surface of the phosphor device, and an output, at which at least one of the conversion light beams coming from the different regions of the phosphor device or the unconverted excitation radiation beams can be provided.

### CROSS-REFERENCE TO RELATED APPLICATION

This application claims priority to German Patent Application Serial No. 10 2016 217 323.5, which was filed Sep. 12, 2016, and is incorporated herein by reference in its entirety.

### TECHNICAL FIELD

Various embodiments relate generally to a light module for generating effect light for lighting, e.g. for applications in the field of entertainment or effect lighting, for example the realization of so-called light fingers (Sky Tracker), tracking spotlights (Follow Spots), stationary and movable effect luminaires (Moving Lights, Wash Lights), etc.

### BACKGROUND

To put it more precisely, various embodiments relate to a light module comprising an excitation light source and a wavelength conversion arrangement. The excitation light source emits excitation light, which with the aid of the wavelength conversion arrangement is converted into light (conversion light) in a different spectral range than the excitation light. The wavelength conversion arrangement usually includes one or more phosphors suitable for the wavelength conversion. In this case, the wavelength conversion need not be complete, but rather can also be carried out only partly. Depending on the thickness and conversion efficiency of the phosphor layer, a corresponding portion is scattered without conversion by the phosphor.

Lasers are typically used as excitation light sources at the present time. These so-called LARP (Laser-Activated Remote Phosphor) light sources have been known for some time for video projection and are based on the conversion of blue laser light, usually generated by a line or matrix of laser diodes, into white useful light with the aid of phosphor converters. Depending on the application, white light is generated for example sequentially as a sequence of red, green and blue light by means of a dynamic or periodically moving LARP arrangement, or continuously as a superimposition of blue and yellow light by means of a static or non-periodically moving LARP arrangement.

For applications in the field of entertainment, continuous-wave white light sources are generally provided in order to avoid undesired artefacts such as in sequential white light generation, e.g. the so-called Color Break. The Color Break phenomenon is a decomposition into the spectral components of which the sequentially generated mixed light is composed, said decomposition being visible to the human eye. This effect may be particularly great if additional movements are superimposed on the light generation, as is customary in particular in the field of entertainment of effect lighting (e.g. Moving Heads, Sky Tracker).

On the other hand, it is desirable to generate effects in a targeted manner, e.g. dynamic changes of colors and light distributions.

### SUMMARY

A light module for providing light includes a plurality of excitation radiation sources, wherein each source is designed to emit an excitation radiation beam at least at times, at least one phosphor designed to convert the excitation radiation impinging on it into conversion light, a phosphor device, which includes the phosphor, and which is designed to re-emit excitation radiation beams impinging on it and at least at times as conversion light beams or unconverted excitation radiation beams, a deflection device having at least one deflection optical unit, which deflection device is designed to direct at least some of the excitation radiation beams coming from the respective excitation radiation sources at times onto different regions of the surface of the phosphor device, and an output, at which at least one of the conversion light beams coming from the different regions of the phosphor device or the unconverted excitation radiation beams can be provided.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1A to 1C show one embodiment of a light module including a phosphor wheel for reflection operation in a first operating phase;

FIGS. 1D to 1F show the light module shown in FIG. 1a in a second operating phase;

FIGS. 2A to 2C show a further embodiment of a light module including a phosphor wheel for reflection operation;

FIG. 3 shows a further embodiment of an optical element for the light module in accordance with FIG. 2A;

FIGS. 4A and 4B show one embodiment of a light module including a phosphor wheel for transmission operation;

FIGS. 5A and 5B show a rotatable deflection device including a plurality of optical elements; and

FIGS. 6A to 6D show the optical elements of the deflection device shown in FIGS. 5A and 5B.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Variuos embodiments specify a light module for providing light effects.

A further aspect is the provision of novel light effects and/or to achieve light effects more simply or with higher brilliance than by means of the light sources used hitherto in the field of entertainment, such as high-pressure discharge lamps or light emitting diodes (LED).

Moreover, protection is sought for a method for operating the light module according to various embodiments.

Various embodiments are found in the dependent claims and the entire disclosure, a distinction between device and method and/or use aspects not always being specifically drawn in the summary; the disclosure should at any rate implicitly be read with regard to all of the claim categories.

A concept of various embodiments may be seen in generating output light from a plurality of individual spots with the aid of a phosphor device and on the basis of LARP technology. The output light provided or emitted at the output of the light module consists, at least at times, of excitation light or converted light or a superimposition of excitation light and converted light. Furthermore, it is provided that the light or illumination pattern formed by the plurality of individual spots can be variable over time.

For this purpose, the light module includes a plurality of excitation radiation sources. Each excitation radiation source is designed to emit an excitation radiation beam at least at times. To that end, at least one portion of the excitation radiation sources can be designed to be drivable.

Moreover, the light module includes a deflection device having a deflection optical unit, which deflection device is designed to direct at least some of the excitation radiation beams coming from the respective excitation radiation sources at least at times onto different regions of the surface of the phosphor device. To that end, the deflection device can be designed to be movable, in particular laterally with respect to the main incidence direction of the excitation radiation beams.

In the context of this disclosure, the term “excitation radiation” means electromagnetic radiation which can be emitted by a laser, for example, and which is not restricted to the visible range with regard to its wavelength, but rather can for example also be in the ultraviolet or infrared. Light radiation in the blue spectral range is preferred, however, since it can be used not only for the excitation of phosphors but also if necessary as a blue light channel. Exemplary wavelengths may be for example in the range of 405 to 480 nm.

The plurality of excitation radiation sources can be formed by a line, a matrix or other collection of excitation radiation sources, for example semiconductor light sources, e.g. light emitting diodes (LED) or laser diodes (LD).

The light module may include a collimation optical unit designed for shaping the excitation radiation beam emitted by each excitation radiation source to form a respective collimated excitation radiation beam. By its nature, the collimation optical unit must be chosen or designed appropriately for the emission characteristic of the light source. For LEDs, which usually have a Lambertian emission characteristic (approximately ±90° emission angle), lens combinations of two lenses are generally necessary for collimation. In the case of LDs, which usually have an emission angle of approximately ±30°, even one lens suffices for collimation. The lenses or lens combinations can also be combined as a matrix composed of individual lens elements.

The collimation optical unit can at least partly also function as a deflection optical unit. In this case, the collimation optical unit is divided into a plurality of separately movable partial optical units, for example individual lens elements. The partial optical units are assigned to individual excitation radiation sources and/or in each case to at least one group of excitation radiation sources. The movement of the partial optical units can be effected for example by means of suitable, drivable actuators, displacement elements or the like, which in this respect can likewise be part of the deflection device. Suitable actuators or displacement elements can be for example piezo-actuators, oscillating coils or other systems known from micro-actuating technology, e.g. those in which the force transmission is realized via a drive spindle moved by an electric motor.

The movement of the collimation optical units or of the partial optical units of the collimation optical unit can take place—proceeding from an initial position in which the collimation optical units are arranged approximately centered in front of the respective excitation radiation sources—in principle in any desired direction. The movement may take place within a plane oriented approximately perpendicularly to the optical axis.

The deflection device may also include at least one further optical element which deflects different excitation radiation beams differently by different reflection or refraction angles. In this case, the optical element by itself or else in combination with adjustable collimation lenses can function as a deflection optical unit. By way of example, the optical element functioning as a deflection optical unit can have a front side and a rear side. The surface of at least one of the two sides has at least one prismlike structure. Prismlike structures here are taken to mean, in particular, structures which have plane surfaces oriented obliquely with respect to the optical axis. Furthermore, however, they are also intended to encompass surface structures having convex or concave sections, e.g. if a defocusing or a variation of the excitation spot size is intended to be effected. Depending on whether a respective excitation radiation beam impinges on one of the prismlike structures and how exactly said structure is embodied, the corresponding deflection is effected for this excitation radiation beam.

In this case, it can be provided that the deflection optical unit can be pivoted into and out of the beam path and/or moved laterally with respect to the main incidence direction of the excitation radiation beams in order to make the light effects variable over time. To that end, a deflection device can be provided which is designed to perform a relative movement between at least one portion of the excitation radiation sources and at least one portion of the deflection optical unit in a plane transversely with respect to the optical axis thereof. In this case, the relative movement may include rotation and/or displacement at least of portions of the excitation radiation sources and/or of the deflection optical unit.

Instead of an integrally produced optical element having prismlike regions or structures, the deflection device may also include a disk-shaped carrier, for example composed of glass, sapphire or metal, into which two or a plurality of separated optical elements having prismlike structures that are generally different from one another are incorporated or in which they are arranged on the surface. Furthermore, these elements, as is usual for similar optical elements in the field of effect light illumination, can be mounted on a disk in such a way that they are also rotatable in each case about their own axis in addition to the rotation of said carrier as already described above.

These and further light effects can also be implemented by changing the drive power of individual excitation radiation sources over time, e.g. also by switching on and off and/or dimming individual excitation radiation sources. To that end, provision is made of corresponding drive electronics for independently driving individual and/or groups of excitation radiation sources.

In any case different excitation radiation beams are thereby directed onto different regions of the surface of the phosphor device at least at times.

Moreover, a collecting optical unit can be provided, which collects the excitation radiation beams emitted by the excitation radiation sources and, if appropriate, deflected by the deflection device in each case onto the different regions of the surface of the phosphor device.

The different regions can be separate from one another and include the same phosphor or else different phosphors, in particular phosphors having different conversion light spectra. In the latter case, besides the spatial light effect a spectral light effect also occurs in addition. Moreover, the surface of the phosphor device can have one or more regions which have no phosphor and are designed to be transparent or reflective for the excitation radiation. At any rate no spectral change in the excitation radiation takes place in these regions. As a result, the for example blue excitation radiation is concomitantly used for the useful light in a spectrally unchanged fashion.

Moreover, an output optical unit can be provided, which collects the conversion light beams coming from the different regions of the phosphor device and, if appropriate, the unconverted excitation radiation beams and directs them to the output of the light module.

The light module according to various embodiments can be arranged for example in a housing of a spotlight. The housing has a light exit opening for the light generated by the light module at the output.

The method for operating the light module according to the invention includes the following:
generating a plurality of excitation radiation beams,
irradiating the phosphor device with the excitation radiation beams,
deflecting one or more excitation radiation beams such that an irradiation pattern is generated by the different excitation radiation beams on the surface of the phosphor device at least at respective points in time.

In the context of this disclosure, the term “irradiation pattern” should be understood to the effect that an irradiation that deviates from an individual excitation beam spot such as usually arises during the imaging or focusing of a collimated excitation radiation beam on a surface of a phosphor device takes place at least at times. Two or more partly overlapping excitation beam spots are also intended to be encompassed by the term “irradiation pattern”. However, irradiation patterns may be provided in which at least two excitation beam spots are non-contiguous. The areal characterization of the excitation beam spots can be carried out for example by way of FWHM (Full Width at Half Maximum) determination of their respective irradiance.

In accordance with the irradiation pattern generated, the surface of the phosphor device emits conversion light beams and/or, if appropriate, unconverted excitation radiation beams. These then form the corresponding useful light, for example for the lighting of an entertainment event.

To that end, it may also be provided, in a further method process, for the light or radiation beams to be collected in a targeted manner, if necessary to be shaped further and/or to be directed and to be provided at the output of the light module or to be coupled out there.

Moreover, it can be provided that the user manually selects the respective deflections of the excitation radiation beams or the light effects generated thereby and these are then repeated for example in a loop and/or that the selection and order of different deflections or light effects are implemented according to a programmable sequence schedule.

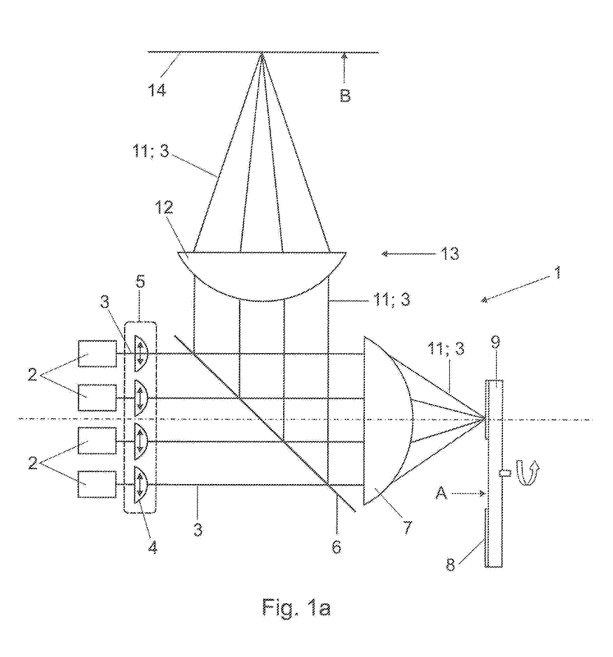

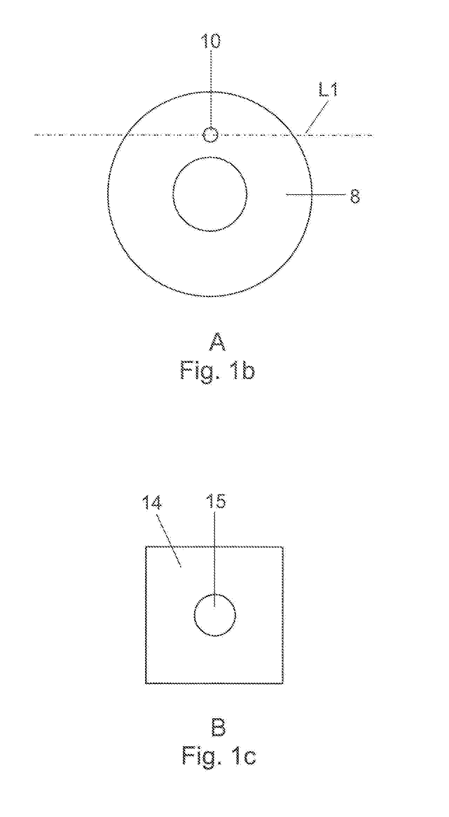

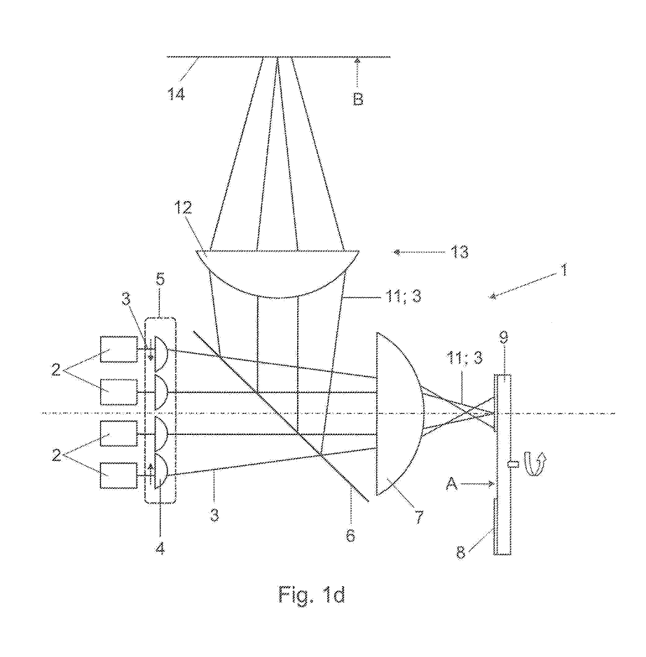

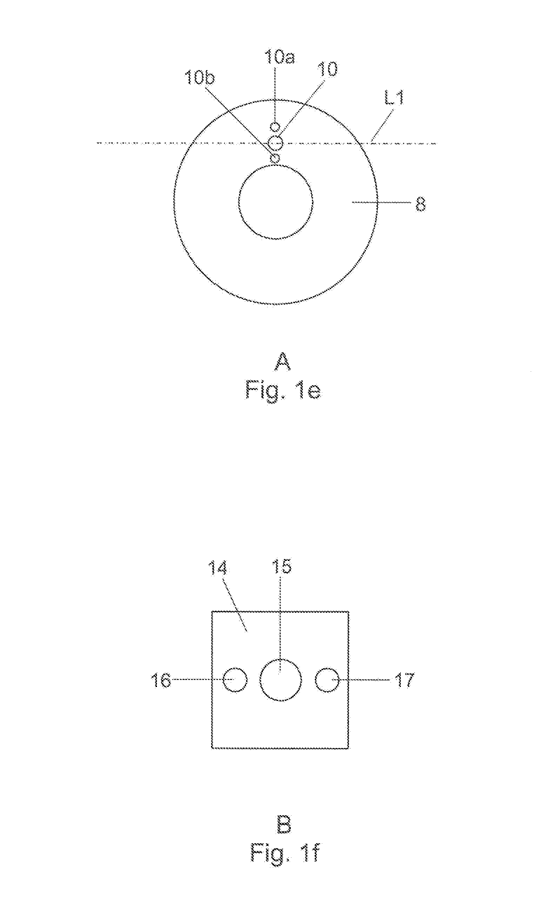

FIG. 1a schematically shows one embodiment of a light module 1 in a first operating phase, the plane of the drawing containing the optical axis L1. The light module 1 includes as excitation radiation sources a matrix of four times four laser diodes 2, although only four laser diodes thereof can be seen in the plane of the drawing. Each laser diode 2 is designed for emitting a laser light beam 3 (symbolized in each case by a line) having a wavelength in the blue spectral range (typically 440 to 460 nm), since in this spectral range a suitable excitation and/or absorption wavelength can be found for most phosphors and suitable semiconductor lasers having the necessary optical radiation power are also available, both with regard to the conversion efficiency and with regard to the preferred dominant wavelength of the phosphor respectively used. Moreover, the blue excitation laser light 3 can also be concomitantly used as blue light channel in this embodiment. Further details concerning this aspect are explained further below.

Each of the laser diodes 2 is assigned a collimation lens 4, which collimates the respective laser light beam (likewise symbolized as a line). Each of the in total sixteen collimation lenses 4 in this example is individually drivable with the aid of a driving arrangement (not illustrated). The driving arrangement includes, inter alia, displacement elements that can displace each collimation lens 4 transversely with respect to the optical axis L1 (symbolized by small double-headed arrows). Alternatively the laser diodes 2 can also be embodied such that they are displaceable relative to the collimation lenses 4. The collimation lenses 4, the displacement elements and the driving arrangement together form the deflection device 5, which is not illustrated in detail but rather, for the sake of better clarity, only symbolically (by dashed lines).

The control in the deflection device 5 can be designed for example such that the user can manually select the respective displacements or light effects and/or these proceed according to a programmable order.

In the operating phase illustrated in FIG. 1A, all the collimation lenses 4 are arranged centered with respect to the laser diodes 2, such that the collimated laser light beams 3 are focused by way of a dichroic mirror 6, which is transmissive to the laser light, with the aid of the collecting lens 7 on the annular phosphor track 8 of a phosphor wheel 9 in the one laser light spot 10 (see also FIG. 1B, which shows a plan view A of the phosphor wheel 9). During operation, the phosphor wheel 9 rotates about its rotation axis, such that the phosphor track 8 rotates through beneath the laser light spot 10. In the case of reflection operation as shown here, the phosphor wheel 9 consists of a reflective carrier material, preferably of a highly reflective metal.

The annular phosphor track 8 can have a structuring (not illustrated) into a plurality of circular and/or annular segments. By way of example, the phosphor track 8 can have two or more different phosphor segments or else one or a plurality of reflective segments without phosphor. Thus, by way of example, in continuous-wave operation, sequential mixed-colored light can be generated or, with the aid of temporally correlated pulsed operation, it is possible to irradiate a specific phosphor segment in a targeted manner and, in the case of a desired light color change, a different phosphor segment with a different conversion light spectrum.

In any case the conversion light beam 11 reflected back from the surface of the phosphor wheel 9 from the region of the laser light spot 10 (so-called reflection operation of a phosphor wheel) is collected by the collecting lens 7 and specularly reflected via the dichroic mirror 6 onto a downstream further collecting lens 12 at the output 13 and is coupled out. In a plane 14 remote from the phosphor wheel, in this case a single bright luminous light spot 15 is generated (see also FIG. 1C, which shows a plan view B of the plane 14). In this case, the plane 14 can be a projection surface, e.g. a wall or area of fog, or else a virtual intermediate plane, which is imaged onto a projection surface by a further projection optical unit.

FIG. 1D schematically shows the same light module 1 in a second operating phase. Here by way of example only the two outer collimation lenses in the plane of the drawing have been displaced slightly inward, indicated by the associated small arrows. As a result, the laser light beams of the associated two outer laser diodes no longer impinge centrally on the respective collimation lens, but rather in a manner displaced with respect thereto on the outer region. Consequently, said laser light beams are slightly deflected inward toward the optical axis L1 . Thus only the non-deflected laser light beams of the remaining fourteen laser diodes (only two thereof can be seen in FIG. 1D) with collimation lenses respectively aligned centrally with respect thereto impinge on a common laser light spot 10 via the collecting lens 7. The laser light beams of the two outer laser diodes are focused on account of the tilting by the collecting lens 7 onto respectively separate laser light spots 10a, 10b and together with the laser light spot 10 form a corresponding irradiation pattern (see also FIG. 1E, which shows a plan view A of the phosphor wheel 9). The conversion light beams emanating from said irradiation pattern consisting of the three separate laser light spots 10, 10a, 10b (said conversion light beams being represented symbolically by lines which coincide with the lines of the excitation light beams in this region, but have opposite directions of propagation) are collected by the collecting lens 7 and specularly reflected via the dichroic mirror 6 onto the downstream further collecting lens 12 at the output 13. In the remote plane 14, in the case of this exemplary situation for a driving of the collimation lenses, a central light spot 15 and on the left and right thereof respectively a further light spot 16, 17 are generated (see also FIG. 1F, which shows a plan view B of the plane 14).

In this way, various dynamic light effects can be generated by lateral displacement of one or more collimation lenses. Said light effects can for example also be supplemented by switching on and off or dimming individual laser diodes, possibly also in correlation with the irradiation of different phosphor segments. By way of example, it is possible to switch back and forth arbitrarily between the central light spot 15 and the left light spot 16 or right light spot 17 or between the central light spot 15 and both outer light spots 16, 17 by virtue of only the corresponding laser diodes being driven while the respective other laser diodes remain off during this time.

It goes without saying that arbitrary other collimation lenses or assigned laser diodes of the light module can also be driven in order thereby to generate other light effects or sequences of different light effects.

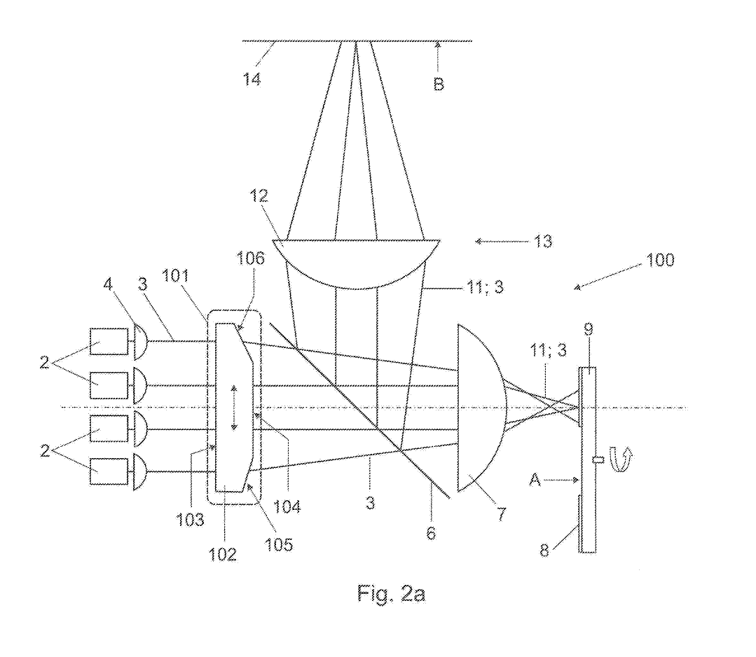

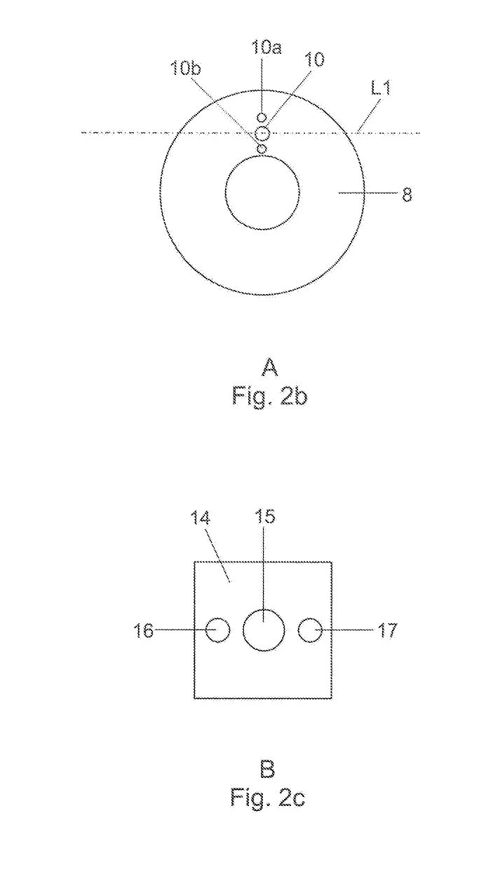

FIG. 2A schematically shows a further embodiment of a light module 100. This differs from the embodiment shown in FIGS. 1A to 1F merely by virtue of the deflection device 101, which here includes an additional optical element 102 as deflection optical unit. The optical element 102 is designed to be displaceable transversely with respect to the optical axis L1 (symbolized by a double-headed arrow) and, as previously in FIG. la, FIG. lb is drivable by means of a driving arrangement (not illustrated in detail). In return, the collimation lenses 4 here are not arranged in a displaceable manner, but rather in a stationary manner.

It can also be provided that the optical element can be pivoted into and out of the beam path or is rotatable in the beam path in a manner similar to a phosphor wheel, wherein the rotation frequency can be adjustable, for example between 0 Hz and approximately 100 Hz, e.g. between 0 Hz and 30 Hz. In this case, the rotation frequency does not have to be fixed at a specific value, but rather can be dynamically variable depending on the application and/or the customer's wishes. Moreover, it can also be provided that not only the optical element but additionally also the collimation lenses are displaceable. Thus, the respective deflections can then be combined.

The optical element 102 has a plane front side 103 facing the collimation lenses 4 and a rear side, the surface of which is designed to be plane in a central region 104 and to taper obliquely outward in the two edge regions 105, 106 (for the sake of simplicity, only the conditions in the plane of the drawing are illustrated and explained here; the surface regions which are assigned to the rest of the LDs and are not visible here can be designed in the same way or else differently). As a result, the optical element 102 has a prismlike structure in each case in the two edge regions 105, 106 whereby the two outer laser light beams are deflected towards the optical axis L1. By contrast, the two central laser light beams shown in the plane of the drawing in FIG. 2A pass without deflection through the central region 104 since the latter acts like a plane-parallel plate. Ultimately, the optical effect of the optical element 102 corresponds to the situation illustrated in FIGS. 1D to 1F. Consequently, both the irradiation pattern 10, 10a, 10b on the phosphor path 8 (see the plan view A in FIG. 2B) and the light pattern 15-17 in the remote plane 14 (see plane view B in FIG. 2C) are the same as in FIG. 1e and FIG. 1f, respectively.

In the optional case of a separate blue channel which is formed only from the excitation light of the laser diodes at respective points in time, in the phosphor wheel 9 parts of the phosphor segments and/or of the reflective carrier material can be replaced by transmissive regions. The blue laser light transmitted by these regions can, for example, be passed back again via three mirrors to the dichroic mirror 6, which is transparent to the blue laser light, in accordance with customary practice in the prior art (so-called “Blue wrap around” or “Blue Loop”). The blue laser light being transmitted again by the dichroic mirror 6 is thus temporally sequentially superimposed with the wavelength-converted light (conversion light) emitted by the phosphor wheel directly in the direction of the dichroic mirror 6 and reflected thereby. Such a Blue Loop is known for example from the documents DE 102012220570 A1 and DE 102012223925 A1.

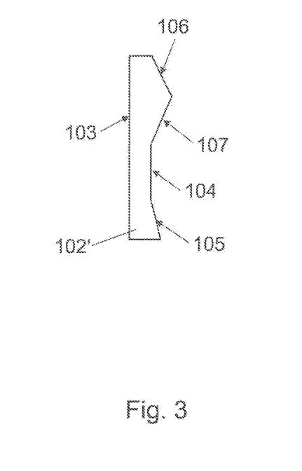

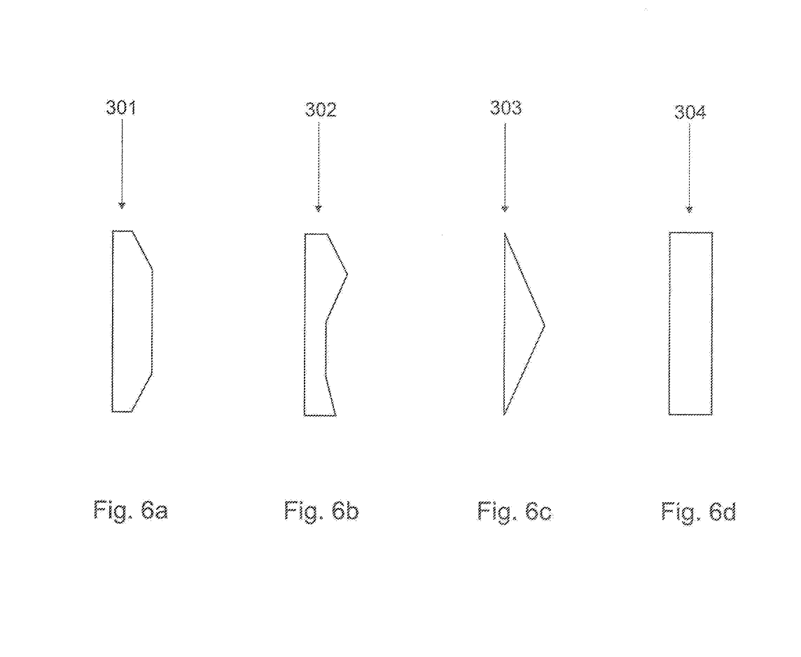

FIG. 3 schematically shows a further embodiment of an optical element 102′ for the light module 100 illustrated in FIG. 2A. The front side 103 is plane as in the case of the optical element 102 in FIG. 2A. However, the surface of the rear side here has four differently shaped regions, which can be assigned respectively to one of the four laser light beams. One region 104 is plane, i.e. the associated laser beam is not deflected here. By contrast, the other three regions 105-107 are shaped in a prismlike manner, i.e. the associated laser beams are correspondingly reflected. It goes without saying that numerous further variations are conceivable for such an optical element (see also FIGS. 6a to 6D).

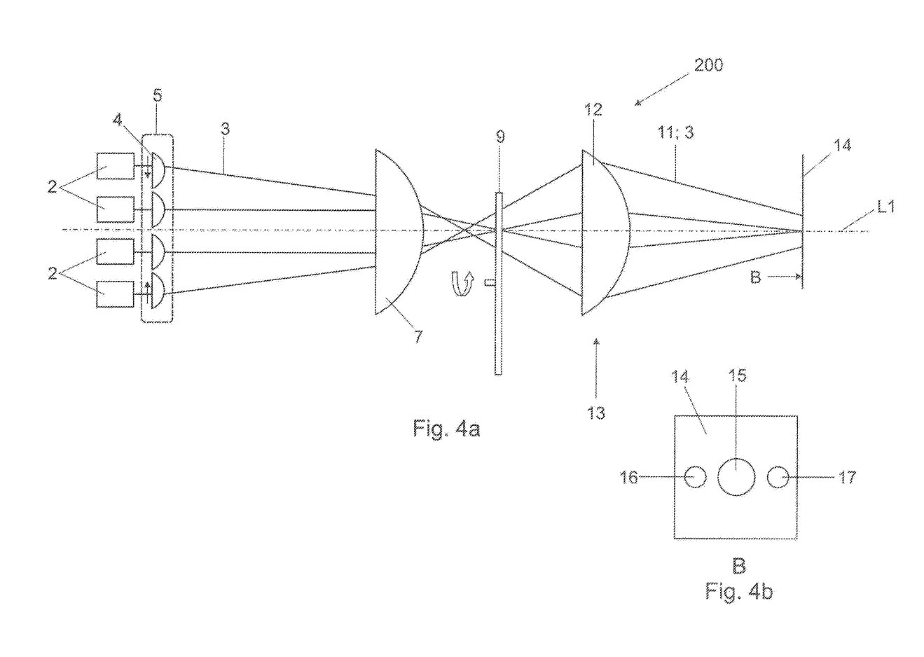

FIG. 4A schematically shows a further embodiment of a light module 200. The light module 200 differs from the light module 1 shown in FIGS. 1A to 1F merely in that the phosphor wheel 9 here is designed for transmission operation instead of reflection operation. Therefore, in contrast to what is otherwise customary, the phosphor path (not visible here) is not applied on a metal plate, but rather for example on a glass plate or sapphire plate in a manner suitably thin for transmission. Here, too, a segment without phosphor conversion, for example a transparency segment or an opening in the plate, can be provided. Moreover, FIG. 4A shows the operating phase illustrated in FIG. 1D; the two outer collimation lenses have thus been displaced somewhat inward toward the optical axis L1 (see small arrows). Consequently, the light pattern 15-17 in a remote plane 14 (see plan view B in FIG. 4B) is also the same as in FIG. 1F.

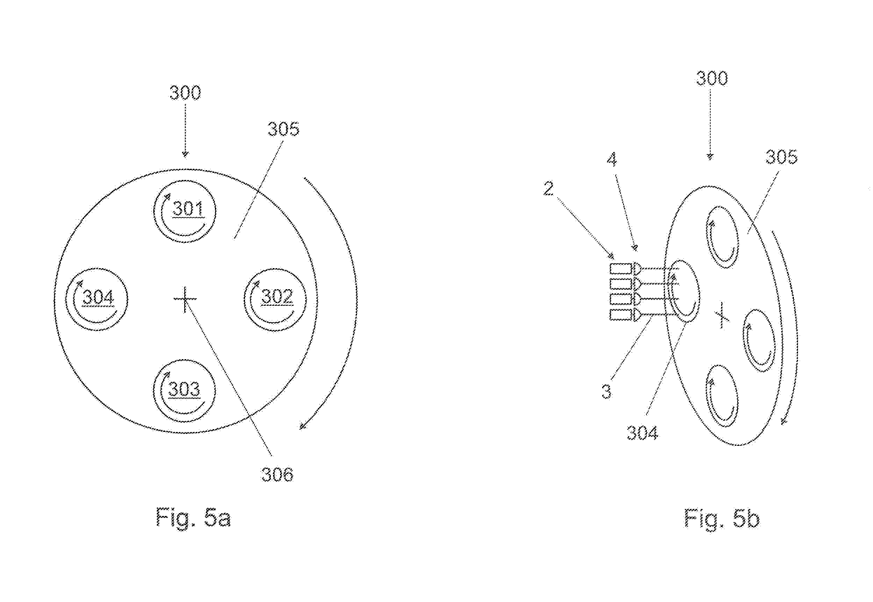

As an alternative to the deflection device 101 illustrated in FIG. 2A, FIG. 5A shows in a schematic plan view a rotatable deflection device 300 including four optical elements 301-304. The four circular optical elements 301-304 are incorporated in a circular-disk-shaped carrier element 305 at a mutual angular distance of 90° and may each be designed themselves for a rotational movement in the plane of the carrier element (symbolized by the smaller rotation arrows). The entire deflection device 300 is designed to be rotatable in the rotation axis 306 (symbolized by the larger rotation arrow). The mechanical and electrical components required for the respective rotational movements are sufficiently known for relevant luminaires for the entertainment industry and are therefore not illustrated here for the sake of better clarity. FIG. 5B shows by way of example a rotary position of the deflection device 300 in which the optical element 304 is rotated into the beam path of the excitation laser light 3 coming from the laser diodes 2 via the collimation lenses 4. As a result, the respective laser light beams 3 of the individual laser diodes 2, in accordance with the configuration and current rotational position of the optical element 304, are if appropriate deflected and correspondingly radiated onto different regions of the phosphor wheel (not illustrated here; see FIG. 2A for example). For the generation of other light effects, the deflection device 300 can be rotated further such that one of the other optical elements 301-303 is positioned into the beam path of the excitation light.

FIG. 6A, FIG. 6B, FIG. 6C, FIG. 6D schematically show the optical elements 301-304 of the deflection device 300 from FIG. 5A, FIG. 5B in detail. Purely by way of example and for the sake of simplicity the respective shapes are once again illustrated only in the plane of the drawing running along the optical axis. The optical elements 301 and 302, respectively, illustrated in FIG. 6A and FIG. 6B correspond to the embodiments illustrated in FIG. 2A and FIG. 3, respectively. The optical element 303 illustrated in FIG. 6C has a triangular profile. By contrast, the optical element 304 illustrated in FIG. 6D corresponds to a plane-parallel optical plate. The optical element 304 will thus usually be rotated into the beam path of the excitation light precisely when only a single conventional spot is provided rather than a deflection. By contrast, the other three optical elements in each case generate different deflections and hence different illumination patterns or light effects which can still be varied dynamically by rotation of the respective optical element.

It goes without saying that a light module according to various embodiments may also include more or fewer than four times four (that is to say a total of sixteen) laser diodes and in a different spatial arrangement in order to generate modified light effects in an identical or similar way.

Furthermore, it goes without saying that static phosphor arrangements can also be used instead of a dynamically rotating phosphor wheel. Inter alia, customary aspects known in the prior art, such as, for example, cooling and heat dissipation for the phosphors used, are crucial for the design of a phosphor arrangement in this regard.

### LIST OF REFERENCE SIGNS

1 Light module

2 Laser diodes

3 Laser light beam

4 Collimation lens

5 Deflection device

6 Dichroic mirror

7 Collecting lens

8 Phosphor track

9 Phosphor wheel

10 Laser light spot

11 Conversion light beam

12 Collecting lens

13 Output of the light module

14 Remote plane

15 Light spot

16 Light spot

17 Light spot

10a, 10b Laser light spot

100 Light module

101 Deflection device

102 Optical element

102′ Optical element

103 Front side

104 Central region of the rear side

105 Edge region of the rear side

106 Edge region of the rear side

107 Further region of the rear side

200 Light module

300 Deflection device having optical elements

301-304 Optical element

305 Carrier element of the deflection device

306 Rotation axis of the carrier element

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A light module for providing light, the light module comprising
a plurality of excitation radiation sources, wherein each excitation radiation source is designed to emit an excitation radiation beam at least at times;
at least one phosphor designed to convert the excitation radiation impinging on it at least partly into conversion light;
a phosphor device, which comprises the at least one phosphor, and which is designed to re-emit at least one of excitation radiation beams impinging on it at least partly and at least at times as conversion light beams or unconverted excitation radiation beams;
a deflection device having at least one deflection optical unit, which deflection device is designed to direct at least some of the excitation radiation beams coming from the respective excitation radiation sources at least at times onto different regions of the surface of the phosphor device;
an output, at which at least one of the conversion light beams coming from the different regions of the phosphor device or the unconverted excitation radiation beams can be provided.

2. The light module of claim 1, further comprising:
a collimation optical unit designed for shaping the excitation radiation beam emitted by each excitation radiation source, to form a respective collimated excitation radiation beam.

3. The light module of claim 2,
wherein the collimation optical unit is embodied as an arrangement of lens elements; and
wherein at least one lens element is assigned to each excitation radiation source.

4. The light module of claim 1, further comprising:
a collecting optical unit, which collects the excitation radiation beams emitted by the excitation radiation sources and, if appropriate, deflected by the deflection device in each case onto the different regions of the surface of the phosphor device.

5. The light module of claim 1, further comprising:
an output optical unit, which collects the conversion light beams coming from the different regions of the phosphor device and, if appropriate, the unconverted excitation radiation beams and directs them to the output.

6. The light module of claim 1,
wherein the deflection optical unit comprises at least one optical element having a front side and a rear side, wherein the surface of at least one of the two sides has at least one prismlike structure.

7. The light module of claim 1,
wherein the collimation optical unit at least partly also functions as a deflection optical unit and wherein the collimation optical unit is divided into a plurality of separately movable partial optical units and the partial optical units are assigned at least one of to individual excitation radiation sources or to a group of excitation radiation sources.

8. The light module of claim 1,
wherein the deflection device is designed to perform a relative movement between at least one portion of the excitation radiation sources and at least one portion of the deflection optical unit in a plane transversely with respect to the optical axis thereof.

9. The light module of claim 8,
wherein the relative movement comprises rotation and/or displacement at least of portions of the excitation radiation sources and/or of the deflection optical unit.

10. The light module of claim 1,
wherein the light module is designed such that the different regions on the surface of the phosphor device are separated from one another.

11. The light module of claim 1,
wherein the excitation radiation sources are designed to be separately drivable individually or in groups.

12. The light module of claim 1,
wherein the phosphor device comprises at least one region which has no phosphor and is designed to be transparent or reflective for the excitation radiation.

13. A method for operating a light module,
the light module comprising:
a plurality of excitation radiation sources, wherein each excitation radiation source is designed to emit an excitation radiation beam at least at times;
at least one phosphor designed to convert the excitation radiation impinging on it at least partly into conversion light;
a phosphor device, which comprises the at least one phosphor, and which is designed to re-emit at least one of excitation radiation beams impinging on it at least partly and at least at times as conversion light beams or unconverted excitation radiation beams;
a deflection device having at least one deflection optical unit, which deflection device is designed to direct at least some of the excitation radiation beams coming from the respective excitation radiation sources at least at times onto different regions of the surface of the phosphor device;
an output, at which at least one of the conversion light beams coming from the different regions of the phosphor device or the unconverted excitation radiation beams can be provided;
the method comprising:
generating a plurality of excitation radiation beams;
irradiating the phosphor device with the excitation radiation beams;
deflecting one or more excitation radiation beams such that an irradiation pattern is generated by the different excitation radiation beams on the surface of the phosphor device at least at respective points in time.

14. The method of claim 13, further comprising;
collecting the different at least one of conversion light beams or unconverted excitation radiation beams coming from the phosphor device in accordance with the irradiation pattern.

15. The method of claim 14, further comprising:
providing the different at least one of conversion light beams or unconverted excitation radiation beams at the output of the light module.

16. A luminaire, comprising:
a light module, comprising:
a plurality of excitation radiation sources, wherein each excitation radiation source is designed to emit an excitation radiation beam at least at times;
at least one phosphor designed to convert the excitation radiation impinging on it at least partly into conversion light;
a phosphor device, which comprises the at least one phosphor, and which is designed to re-emit at least one of excitation radiation beams impinging on it at least partly and at least at times as conversion light beams or unconverted excitation radiation beams;
a deflection device having at least one deflection optical unit, which deflection device is designed to direct at least some of the excitation radiation beams coming from the respective excitation radiation sources at least at times onto different regions of the surface of the phosphor device;
an output, at which at least one of the conversion light beams coming from the different regions of the phosphor device or the unconverted excitation radiation beams can be provided.

17. The luminaire of claim 16,
configured as a spotlight luminaire for application in the entertainment sector.
